(19) United States
(12) Patent Application Publication
(10) Pub. No.: US 2003/0033177 A1
(43) Pub. Date: Feb. 13, 2003

(54) Method, system and storage medium for customer order processing

(76) Inventors: Richard G. MacGonigle, Leeds, NY (US); Cheryl Lynn Woitte, Oshawa, CA (US); James Edmond Gosselin, Pittsfield, MA (US); Marcos Vincio Perello, East Greenbush, NY (US)

Correspondence Address: CANTOR COLBURN, LLP, 55 GRIFFIN ROAD SOUTH, BLOOMFIELD, CT, 06002

(21) Appl. No.: 09/682,262

(22) Filed: Aug. 10, 2001

(51) Int. Cl. G06F 17/60

(52) U.S. Cl. 705/7

(57) ABSTRACT

An exemplary embodiment is a method, system and storage medium for customer order processing. The system includes a host system for generating a computer program purchase order template for receiving customer order data corresponding to a customer order, receiving said customer order data and generating a purchase order based on said customer order data in said computer program purchase order template. A network is coupled to the host system, and a database is coupled to the host system.

### BACKGROUND OF INVENTION

The invention relates generally to production line management, and more specifically, to a method, system and storage medium for customer order processing.

Many production lines, such as in the plastics industries, involve numerous processes to create an end product. In production lines where intricate or otherwise information-sensitive manufacturing is performed, fast and accurate customer order processing is needed. Without efficient, fast and accurate customer order processing, numerous errors may occur.

For example, in the plastics manufacturing industry, currently there are many process steps and time delays to take a customer order from receipt to manufacture. These steps and delays often involve manual processes, system interfaces and batch jobs which encompass order entry, master scheduling, line scheduling, and formula verification. Thus, the time from receiving an order to the time the order is available to the production line is lengthy. Further, potential human error increases time delays, costs and the potential for discrepant end products.

Typically, customer order processing is logistically complex, costly and difficult to manage. Due to potential human error with manual customer order processing methods, discrepant, questionable, flawed or incorrect end products may be ultimately delivered to a customer.

Thus, there is a need for a more efficient, fast and accurate method and system for customer order processing.

### SUMMARY OF INVENTION

An exemplary embodiment is a method, system and storage medium for customer order processing. The system includes a host system for generating a computer program purchase order template for receiving customer order data corresponding to a customer order, receiving said customer order data and generating a purchase order based on said customer order data in said computer program purchase order template. A network is coupled to the host system, and a database is coupled to the host system.

### BRIEF DESCRIPTION OF DRAWINGS

Referring now to the drawings wherein like elements are numbered alike in several FIGURES:

FIG. 1 is a block diagram of an exemplary system for customer order processing in one embodiment;

FIG. 2 depicts an exemplary computer program template in one embodiment; and

FIG. 3 illustrates an exemplary method for customer order processing in one embodiment.

### DETAILED DESCRIPTION

Although the examples of the embodiments described herein relate to the plastics industry, it should be appreciated that the embodiments may also be applied to other manufacturing customer order processing environments.

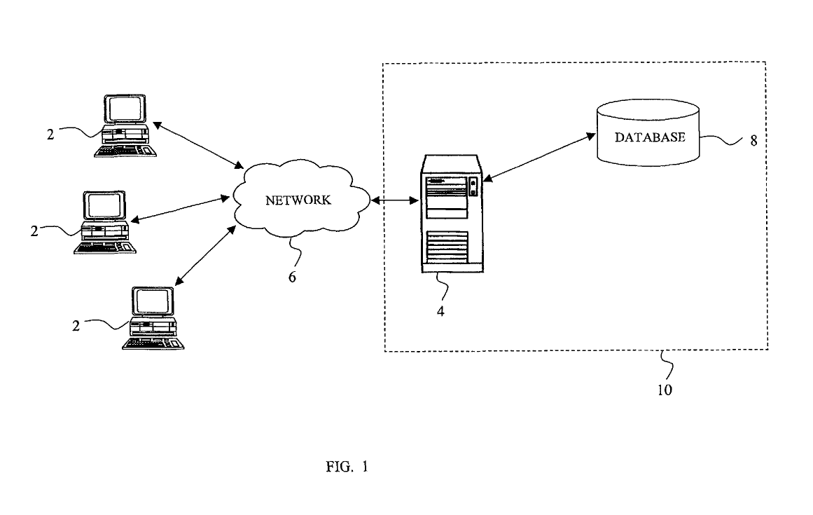

FIG. 1 is a block diagram of a system for customer order processing in one embodiment of the invention. The system includes one or more user systems 2 coupled to a host system 10 via a network 6. Each user system 2 may be implemented using a general-purpose computer executing a computer program for carrying out the processes described herein. The network 6 may be any type of known network including a local area network (LAN), wide area network (WAN), global network (e.g., Internet), intranet, extranet, etc. The user systems 2 may be coupled to the host system 10 through multiple networks (e.g., intranet and Internet) so that not all user systems 2 are coupled to the host system 10 via the same network. One or both of the user systems 2 and the host system 10 may be connected to the network 6 in a wireless fashion and network 6 may be a wireless network. In a preferred embodiment, the network 6 is the Internet and user system 2 executes a user interface application (e.g., Web browser) to contact the host system 10 through the network 6. Alternatively, a user system 2 may be implemented using a device programmed primarily for accessing network 6 such as WebTV or a network computer.

The host system 10 includes a processor, such as a server 4 operating in response to a computer program stored in a storage medium accessible by the server. The server 4 may operate as a network server (often referred to as a Web server) to communicate with the user systems 2. The server 4 handles sending and receiving information to and from user systems 2 and may perform associated tasks. The server 4 may also include a firewall to prevent unauthorized access to the host system 10 and enforce any limitations on authorized access. The firewall may be implemented using conventional hardware and/or software as is known in the art.

The server 4 may also operate as an applications server. In other words, the server 4 may execute one or more computer programs to interact with a database 8. It is understood that separate servers may be used to implement the network server functions and the applications server functions. Alternatively, the network server, firewall and the applications server may be implemented by a single server executing computer programs to perform the requisite functions.

The database 8 may contain a variety of information related to customer order processing. The database 8 may be contained in a legacy, mainframe system and the server 4 may interact with the database 8 through existing legacy components. In the alternative, the database 8 may be contained in or co-located with the server 4. Changes to database 8 may be made dynamically, in real time to instantaneously update information contained in the database 8.

A user system 2 may be used by a customer service representative (CSR) for entering a customer's order. Additionally, or in the alternative, a user system 2 may be used by a customer for entering an order, such as via a vendor's Web site (e.g., GEPolymerland.com).

An embodiment may include utilizing Design For Six Sigma (DFSS) techniques for various aspects of customer order processing. One aspect may include expediting certain customer orders based on a price premium or other factor. DFSS is a well known, disciplined approach using statistical tools to define a problem, measure current performance, design, engineer, implement solutions and measure success. The order entry system (ESS) of FIG. 1 may include a computer program purchase order template (not shown), which captures order information and automatically creates a purchase order. In general, the template may include all customer order information for a particular production line product. Note that the purchase order generation routine may automatically create a purchase order from the order information due to the structured, recognizable format of the purchase order template. However, free format notes may not be recognized by the purchase order generation routine, and orders containing free format notes may be rejected and materials management notified of an order requiring manual review and purchase order generation. At the time of order entry, when a customer requests an expedited order, the CSR may access a notes template as described below.

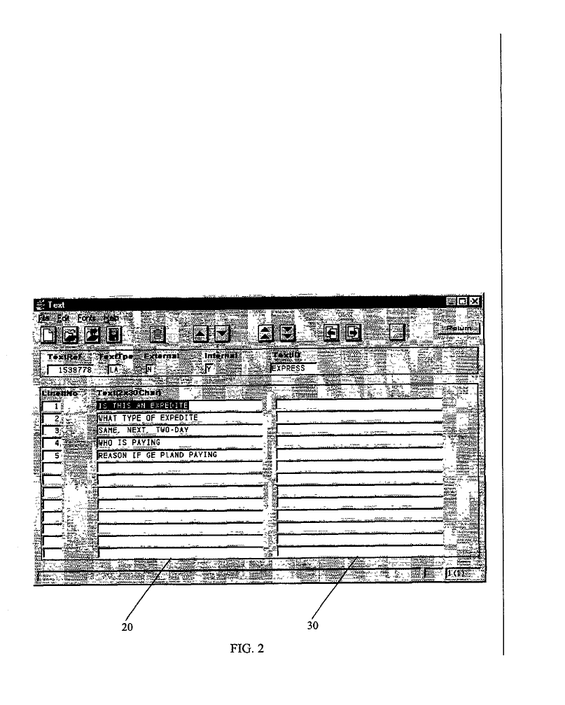

In one embodiment, a computer program notes template may be used to facilitate the entry of notes associated with orders that are to be expedited. Referring to FIG. 2, the template may include a set of questions to be answered by a CSR. The template shown in FIG. 2 standardizes these notes and allows the order to flow through the ESS wherein a software routine may automatically generate a purchase order. Thus, when entering an expedited order into ESS, the CSR may use this template to enter information. For example, the text column 20 of the exemplary template includes typical questions that may be asked to a potential customer. The answer column 30 is used to enter the corresponding answers. Note that this embodiment precludes previous practices that required the CSR to enter notes in a free format (e.g., informational notes added in an unstructured format), which then required review by personnel in materials management to ensure all necessary information was present. Thus, the template allows for bypassing materials management, and streamlines the order/purchase order generation process.

The database receives a manufacturing demand in real time from the order entry system, thus, eliminating delays commonly associated with batch processing. An automatic scheduling routine places the customer's order on the correct manufacturing line, and initiates batch and Lot No. creation routines. The automatic scheduling routine may run in real time, 24 hours a day, without human intervention. Based on product, color and order size routing rules, as well as current line status, the scheduling routine may determine the appropriate manufacturing line for producing an order. The scheduling routine may also create the appropriate “run size” (i.e., the quantity to be produced) of a given product at a given time. This may be determined by the number and size of orders to be produced, as well as the minimum or maximum quantities that a production line is capable of producing. A shop floor notification process may be used to alert manufacturing of a new customer order. The shop floor notification process may include automatic printing of a new schedule for a particular production line, along with electronic notification at a production line control panel.

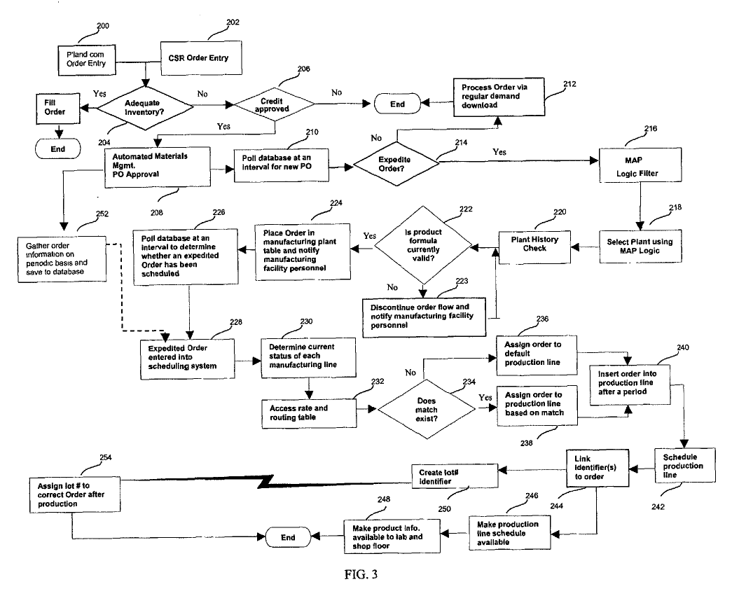

Operation of the system will now be described. Referring to FIG. 3, the customer's order may be entered by either a CSR as shown in step 202, or by the customer as shown in step 200. As previously discussed, the customer's order may be entered via a user system 2. The computer program template may be presented via the user system 2 for facilitating the order entry. In step 204, the order is placed in the ESS, and inventory is checked to determine whether there is adequate inventory to fill the customer order. If there is no inventory, then the order becomes a manufacturing demand requiring production, and the order flow proceeds to step 206.

Step 206 determines whether the customer's credit is approved. If not, the process ends. Otherwise, in step 208, an automated materials management process may be used to approve the order. For example, once the order is entered in the ESS and step 206 is approved, the order becomes a manufacturing demand for production. This may be facilitated by the creation of a purchase order (ESS PO). Since all necessary information is captured in the computer program templates, the ESS PO creation is automatic. After step 208, the order flow may follow two paths (step 252 and step 210). Step 252 is described below. In step 210, the new ESS PO's are downloaded to an electronic table. At an interval (e.g., one minute), the database may poll the table to determine whether there is a new PO to be processed. Next, the best manufacturing plant to run the order is determined. First, step 214 determines whether the order is to be expedited. If not, in step 212, no further automated processing takes place. For example, the order may be processed at a later date/time via the regular demand download to the scheduling system. Otherwise, in step 216, the order passes through a manufacturing assignment process (MAP) software logic filter as discussed in step 218.

In step 218, a manufacturing plant may be selected based on various factors. For example, in an embodiment used for the plastics manufacturing industry, such factors may include order size, product type and product color. The MAP logic assigns a customer order to a particular manufacturing site. The assignment may be based on user-controlled business rules. The rules may be based on the capability of a particular site to run certain products. For example, for a glass filled plastic product, an actual glass feeder may be required on the manufacturing line. The assignment prevents an order from going to a manufacturing site that is not capable of producing the product. Thus, every manufacturing line may be pre-qualified to run a certain product. Other examples would be products requiring FDA approval, fire retardant codes and special effects codes.

The MAP logic filter may include a capability table of rules that determine which plant an order will be manufactured at. Purchase orders that are released to manufacturing become the candidates for the rules. The orders may be tested against the rules. If an order meets the criteria for one of the rules, and the plant associated with the rule is a valid manufacturing plant for the product, then it will become the manufacturing plant for the purchase order. There may be several layers of rules. The highest layer may be the exception rule (e.g., specific products that cannot be manufactured through this process). The lowest layer is the default rule (if order does not meet any of the rules). The middle layers may be used to further refine where a purchase order may be manufactured. Note that a purchase order may meet the criteria of one or more rules at a time. The highest layered rule prevails. Each rule may have a business code and quantity associated with it. The business code may determine which products will be effected by the rule. The quantity may determine the largest quantity an order may be for, and still be valid for the rule. The rule's quantity may be compared to the order's release to manufacture quantity. Other optional layers may further limit a rule's scope. They may include such things as PSI family, grade-color code, manufacturing product category, grade, color, etc. All the fields may be used as specific values or a range of values. Each rule may include a plant and model code that are applied to an order once it meets the rule criteria. Exception rules may have a blank plant to indicate that no manufacturing facility is currently able to handle the purchase order.

Next, in step 220, the manufacturing plant history may be checked. For example, for a plastics application, plant manufacturing history may be checked to determine whether the plastic grade/color has been previously manufactured at the selected site. This may be easily determined by checking a product specification history (PSH) database containing such information. The database containing the plant manufacturing history may be updated at an interval to allow for a determination of the frequency and/or last time a particular product was made at a particular facility. Step 222 determines whether a valid product formulation exists for the order. This may be accomplished by searching a product formulation database. If no valid product formulation exists, then in step 223, the order flow is discontinued and manufacturing facility personnel are notified that the product formula is not currently valid. Once the product formula becomes validated, then flow continues to step 224.

In step 224, the order is placed in an electronic table corresponding to the manufacturing site chosen to fill the order. Each site may have a corresponding table in the database to help determine whether expedited orders have been previously scheduled at the site. Once the order is placed in the table, the appropriate manufacturing site personnel is automatically notified of the order (e.g., via e-mail). In step 226, the database is polled at an interval (e.g., every 3 minutes) by each manufacturing site to determine whether an expedited order has been scheduled for the particular site (e.g., by being placed on the corresponding manufacturing plant table.)

As previously mentioned, order flow from step 208 may also go to step 252, which is described next. Note that flow from steps 252 and 226 go to step 228 described below. In step 252, the order information may be gathered and transferred to a database for saving orders that require manufacturing after entry to the ESS. The order information may be gathered on a periodic basis (e.g., 30 minutes). This initiates the creation of a requisition number, which is unique to the order and is representative of the order information by mirroring the order information that is contained in ESS for the specific customer order. The order information may also be sent to the database at a frequent interval (e.g., every 3 minutes). After production of the order is complete, the product is assigned to the requisition number so that it may be shipped to the original ordering customer. The dotted line from step 252 to step 228 indicates order flow into a scheduling system.

The scheduling system may include software programs for determining the appropriate manufacturing line for producing an order. This may be based on product, color and order size along with routing rules and current line status. The scheduling system may determine appropriate “run size” (e.g., the quantity to be produced of a given product at a given time.) For example, this may be determined by the number and size of orders to be produced, as well as the minimum or maximum quantities that a production line is capable of producing. Order information downloaded to the scheduling system may include product, color, quantity, package type, etc.

The scheduling system compares orders from step 252 to the orders that come through step 226 and disregards duplicate orders. In step 230, when an expedited order is polled into the scheduling system, the scheduling system may determine the current production status of each production line. Next, in step 232, the scheduling system may access a table including each production line's capabilities at the time (e.g., rate and routing information). Thereafter, the table may be updated with changes or additions to the production line capabilities. In step 234, the scheduling system looks for a match between the expedited order details and the rate and routing information for each production line. If a match is found, in step 238, the scheduling system may assign the expedited order to the production line where the match was found. If no match is found, in step 236, the system may assign the expedited order to a ‘default’ line, which has been predetermined to have flexible manufacturing capability. After assigning the order to a production line, in step 240, the scheduling system may insert the expedited order into that line's production schedule after a period of time. In step 242, a production line for producing the order is scheduled.

In step 244, any previously assigned unique identifier is linked and verified to the order to allow for traceability through the software system routines. For example, each system may generate its own unique identifier, which is linked to the original purchase order. Thus, any linked identifier may be used in a query to identify and/or verify the order at any point in the manufacturing order process. Step 250 allows for the creation of a lot number identification to be correlated to the order.

In step 254, the lot number may be assigned to the correct order after production, and so that the completed order ships to the correct customer. In step 246, the production line schedule is made available. As part of a shop floor notification process, when a new order is scheduled, an updated schedule may be printed for the line that is to process the new expedited order. In step 248, all of the product information, such as formulation and processing for the grade/color, of a plastic associated with the order, may be made available to the lab and manufacturing floor.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. A system for customer order processing, the system comprising:
a host system for generating a computer program purchase order template for receiving customer order data corresponding to a customer order, receiving said customer order data and generating a purchase order based on said customer order data in said computer program purchase order template;
a network coupled to said host system; and
a database coupled to said host system.

2. The system of claim 1, further including:
a user system coupled to said network; and
said user system accessing said host system via said network.

3. The system of claim 1, further including said host system:
determining whether said customer order is to be expedited;
determining whether inventory exists to fill said customer order;
scheduling the production of said customer order if inventory does not exist to fill said customer order; and
wherein said scheduling includes determining a manufacturing facility for producing a product based on said customer order.

4. The system of claim 3, wherein said determining whether said customer order is to be expedited includes said host system:
generating a computer program notes template for receiving a note associated with said customer order;
receiving a note associated with said customer order;
wherein said generating said purchase order further includes generating said purchase order including said note associated with said customer order.

5. The system of claim 3, wherein said determining a manufacturing facility for producing said product includes said host system:
correlating a table of rules to said purchase order;
wherein said table of rules includes criteria for determining the capability of said manufacturing facility to produce a product correlating to said purchase order.

6. The system of claim 5, wherein said criteria for determining the capability of said manufacturing facility to produce said product includes said host system:
determining whether said manufacturing facility has previously produced said product; and
determining whether said manufacturing facility can produce a specified quantity of said product.

7. The system of claim 3, wherein said scheduling further includes said host system determining a production line at said manufacturing facility for producing said product.

8. The system of claim 7, wherein said determining said production line includes said host system:
accessing a capability table based on the capability of said production line to produce said product; and
determining the current production status of said production line based on said capability table.

9. The system of claim 8, further including said host system updating said capability table on a periodic basis.

10. A system for customer order processing, the system comprising:
a host system for generating a computer program purchase order template for receiving customer order data corresponding to a customer order, receiving said customer order data, generating a computer program notes template for receiving a note associated with said customer order, receiving a note associated with said customer order and generating a purchase order based on said customer order data in said computer program purchase order template and said note associated with said customer order;
a network coupled to said host system; and
a database coupled to said host system.

11. The system of claim 10, further including:
a user system coupled to said network; and
said user system accessing said host system via said network.

12. A system for customer order processing, the system comprising:
a host system for generating a computer program purchase order template for receiving customer order data corresponding to a customer order, receiving said customer order data, generating a purchase order based on said customer order data in said computer program purchase order template and determining a manufacturing facility for fulfilling said purchase order;
a network coupled to said host system; and
a database coupled to said host system.

13. The system of claim 12, further including:
a user system coupled to said network; and
said user system accessing said host system via said network.

14. A system for customer order processing, the system comprising:
means for generating a computer program purchase order template for receiving customer order data corresponding to a customer order;
means for receiving said customer order data; and
means for generating a purchase order based on said customer order data in said computer program purchase order template.

15. A method for customer order processing, the method comprising:
generating a computer program purchase order template for receiving customer order data corresponding to a customer order;
receiving said customer order data; and
generating a purchase order based on said customer order data in said computer program purchase order template.

16. The method of claim 15, further including:
determining whether said customer order is to be expedited;
determining whether inventory exists to fill said customer order;
scheduling the production of said customer order if inventory does not exist to fill said customer order; and
wherein said scheduling includes determining a manufacturing facility for producing a product based on said customer order.

17. The method of claim 16, wherein said determining whether said customer order is to be expedited includes:
generating a computer program notes template for receiving a note associated with said customer order;
receiving a note associated with said customer order;
wherein said generating said purchase order further includes generating said purchase order including said note associated with said customer order.

18. The method of claim 16, wherein said determining a manufacturing facility for producing said product includes:
correlating a table of rules to said purchase order;
wherein said table of rules includes criteria for determining the capability of said manufacturing facility to produce a product correlating to said purchase order.

19. The method of claim 18, wherein said criteria for determining the capability of said manufacturing facility to produce said product includes:
determining whether said manufacturing facility has previously produced said product; and
determining whether said manufacturing facility can produce a specified quantity of said product.

20. The method of claim 16, wherein said scheduling further includes determining a production line at said manufacturing facility for producing said product.

21. The method of claim 20, wherein said determining said production line includes:
accessing a capability table based on the capability of said production line to produce said product; and
determining the current production status of said production line based on said capability table.

22. The method of claim 21, further including updating said capability table on a periodic basis.

23. A method for customer order processing, the method comprising:
generating a computer program purchase order template for receiving customer order data corresponding to a customer order;
receiving said customer order data;
generating a computer program notes template for receiving a note associated with said customer order;
receiving a note associated with said customer order; and
generating a purchase order based on said customer order data in said computer program purchase order template and said note associated with said customer order.

24. A method for customer order processing, the method comprising:
generating a computer program purchase order template for receiving customer order data corresponding to a customer order;
receiving said customer order data;
generating a purchase order based on said customer order data in said computer program purchase order template; and
determining a manufacturing facility for fulfilling said purchase order.

25. A storage medium encoded with machine-readable computer program code for customer order processing, the storage medium including instructions for causing a processor to implement a method comprising:
generating a computer program purchase order template for receiving customer order data corresponding to a customer order;
receiving said customer order data; and
generating a purchase order based on said customer order data in said computer program purchase order template.

26. A storage medium encoded with machine-readable computer program code for customer order processing, the storage medium including instructions for causing a processor to implement a method comprising:
generating a computer program purchase order template for receiving customer order data corresponding to a customer order;
receiving said customer order data;
generating a computer program notes template for receiving a note associated with said customer order;
receiving a note associated with said customer order; and
generating a purchase order based on said customer order data in said computer program purchase order template and said note associated with said customer order.

27. A storage medium encoded with machine-readable computer program code for customer order processing, the storage medium including instructions for causing a processor to implement a method comprising:
generating a computer program purchase order template for receiving customer order data corresponding to a customer order;
receiving said customer order data; generating a purchase order based on said customer order data in said computer program purchase order template; and
determining a manufacturing facility for fulfilling said purchase order.

28. A computer data signal for customer order processing, said computer data signal comprising code configured to cause a processor to implement a method comprising:
generating a computer program purchase order template for receiving customer order data corresponding to a customer order;
receiving said customer order data; and
generating a purchase order based on said customer order data in said computer program purchase order template.

29. A computer data signal for customer order processing, said computer data signal comprising code configured to cause a processor to implement a method comprising:
generating a computer program purchase order template for receiving customer order data corresponding to a customer order;
receiving said customer order data;
generating a computer program notes template for receiving a note associated with said customer order;
receiving a note associated with said customer order; and
generating a purchase order based on said customer order data in said computer program purchase order template and said note associated with said customer order.

30. A computer data signal for customer order processing, said computer data signal comprising code configured to cause a processor to implement a method comprising:
generating a computer program purchase order template for receiving customer order data corresponding to a customer order;
receiving said customer order data; generating a purchase order based on said customer order data in said computer program purchase order template; and
determining a manufacturing facility for fulfilling said purchase order.
